(19) United States
(12) Patent Application Publication
(10) Pub. No.: US 2024/0116206 A1
(43) Pub. Date: Apr. 11, 2024

(54) DEVICE FOR PROVIDING EDGE BANDS, EDGE BANDING SYSTEM HAVING SUCH A DEVICE, AND METHOD FOR CHANGING AN EDGE ROLLER OR EDGE CARTRIDGE

(71) Applicant: IMA Schelling Deutschland GmbH, Lübbecke (DE)

(72) Inventors: Lars CULEMANN, Stemwede (DE); Tim KOTTKAMP, Lübbecke (DE); Simon KRÖKER, Espelkamp (DE); Hendrik GERDWILKER, Lübbecke (DE); Timo HEIDENREICH, Hüllhorst (DE); Stefan HÜSENER, Hille (DE); René PETKER, Bergisch Gladbach (DE); Björn STUKE, Lübbecke (DE)

(73) Assignee: IMA Schelling Deutschland GmbH, Lübbecke (DE)

(21) Appl. No.: 18/263,596

(22) PCT Filed: Feb. 19, 2021
(86) PCT No.: PCT/EP2021/054140

§ 371 Date: Jul. 31, 2023

(51) Int. Cl. B27D 5/00

(52) U.S. Cl. CPC B27D 5/003

(57) ABSTRACT

A device for providing edge bands has a storing unit having individual storage places, which are designed to be at least indirectly loaded with edge bands, in particular edge bands that each form an edge roller at least in some portions. The storing unit is arranged to be linearly movable in or on a base frame such that a selected edge roller can be moved into a working position in which the edge band located on the edge roller can be taken over by an edge feed of an edge banding machine. A portion of an edge band, in particular a portion unwound from an edge roller, can be separated at a cutting position in the region of the working position by means of at least one cutting arrangement.

### CROSS REFERENCE TO RELATED APPLICATIONS

This patent application is the US National Phase of and claims priority on and the benefit of International Application No. PCT/EP2021/054140 having an international filing date of 19 Feb. 2021.

### BACKGROUND OF THE INVENTION

### Technical Field

The invention relates to a device for providing edge bands comprising a storing unit having individual storage places, which are designed to be at least indirectly loaded with edge bands—in particular, edge bands that each form an edge roller at least in some portions—wherein the storing unit is arranged to be linearly movable in or on a base frame such that a selected edge roller can be moved into a working position in which the edge band located on the edge roller can be taken over by an edge feed of an edge banding machine, and to an edge banding system having a device of this type, wherein the at least one device is arranged in the region of the edge banding machine in such a way that at least one edge band that can be arranged in the device can be fed directly from the storing unit of the device at least in some portions to the edge banding machine. The invention further relates to a method for changing an edge roller or edge cartridge characterized in that the following steps are performed: a) a first edge band located in the edge feed is cut off from a first edge roller and with the cutting arrangement at a cutting position; b) the peeled off edge band remaining on the first edge roller is optionally retracted; c) the storing unit is displaced such that the first edge roller is moved out of the working position, and a second edge roller is moved into the working position; and d) the edge band located on the second edge roller is captured by the edge feed and fed to processing, and to using the device or the edge banding system wherein the respective edge band is removed from a cartridge which contains the edge band at least partially and which is received by one of the storage places.

### Prior Art

Panels made from wood or wood substitute materials for the furniture industry usually have at least one at least partially coated top surface before they are processed. The types of these coatings range from paintwork to cladding with layers of real wood veneer or plastic. In addition to the particular optics, the surfaces coated in this way have an increased resistance to mechanical influences and liquids. The narrow edges of these panels are usually coated only afterwards—for instance, after they have been cut to size. In the context of the so-called edge banding, a suitable edge band is attached to the narrow sides of the panel at least in some portions. Its bond with the panel is usually based upon adhesion or a micro-form fit by local melting.

In an industrial context, the edge banding of wood-based panels is carried out using an edge banding system in which the edge bands are attached by at least one edge banding machine. The edge bands are usually available in rolled-up form as edge rollers, so that even long lengths can be safely transported and stored in the most compact way possible. For the simplest possible handling, they can also be arranged within a cartridge and, if necessary, can be unwound therefrom. Due to the variety of colors and decors as well as the thicknesses (depth) of the panels to be edge banded, the edge bands, which are then also different, often have to be exchanged for the appropriate variant.

A device for providing edge bands which comprises a tower-like storing unit is known from EP 1 346 805 A2. The storing unit has individual storage places which are designed for at least indirect loading with edge bands. The storage places are located one above the other with respect to a vertical.

In the specific embodiment, a storage place of the storing unit serves as a fixed place-changing position, which corresponds to a storage table arranged on the outside of the storing unit and located at the same height. From the storage table, a cartridge loaded with an edge roller can be manually introduced into the place-changing position. This cartridge is then sorted into another storage place within the storing unit by a handling apparatus arranged on the opposite side of the storing unit. Conversely, a cartridge to be exchanged is first pulled out of its storage place within the storing unit by means of the handling apparatus and is transferred to the place-changing position, from where it is removed again manually and, for example, placed on the storage table for insertion of a new edge roller. An edge banding machine is supplied with edge bands via the handling apparatus of the device, which removes the required cartridge from the storing unit and transfers it to the edge banding machine.

Changing, in particular, between different edge bands or the cartridges containing them is sometimes complex. The reason for this is the always necessary interposition of the handling apparatus, which is needed both for the distribution of the edge bands within the storing unit and for the supply of the edge banding machine with the edge bands that are required in each case. The change is time-consuming in particular when portions of edge bands are still located in the feed line of the edge feeding unit of an edge banding machine when the edge band is to be changed. In such a case, the edge band that is no longer required must first be retracted from the feed line before a new edge band can be inserted.

### BRIEF SUMMARY OF THE INVENTION

The object of the present invention is therefore to further develop a generic device and an edge banding system equipped therewith such that the provision of edge bands can take place more economically overall.

In a device for providing edge bands, this object is achieved according to the invention by a device for providing edge bands, comprising a storing unit having individual storage places which are designed to be at least indirectly loaded with edge bands—in particular, edge bands that each form an edge roller at least in some portions—wherein the storing unit is arranged to be linearly movable in or on a base frame such that a selected edge roller can be moved into a working position in which the edge band located on the edge roller can be taken over by an edge feed of an edge banding machine, characterized by at least one cutting arrangement, by means of which a portion of an edge band—in particular, a portion unwound from an edge roller—can be separated at a cutting position in the region of the working position. This object is further achieved by an edge banding system comprising an edge banding machine and at least one device as taught herein, wherein the at least one device is arranged in the region of the edge banding machine in such a way that at least one edge band that can be arranged in the device can be fed directly from the storing unit of the device at least in some portions to the edge banding machine and by a method for changing an edge roller or edge cartridge in an edge banding system as taught herein, characterized in that the following steps are performed: a) a first edge band located in the edge feed is cut off from a first edge roller and with the cutting arrangement at a cutting position; b) the peeled off edge band remaining on the first edge roller is optionally retracted; c) the storing unit is displaced such that the first edge roller is moved out of the working position, and a second edge roller is moved into the working position; and d) the edge band located on the second edge roller is captured by the edge feed and fed to processing. The respective dependent claims relate to advantageous embodiments.

It is proposed that the device shall comprise a base frame, wherein the actual storing unit is now arranged so as to be linearly movable in or on this base frame. In other words, the device according to the invention can stand on a base above its base frame and/or can be fastened to another component, while the storing unit designed to accommodate edge bands is disposed to be linearly movable relative to the base frame. According to the invention, this takes place in that a selected edge roller can be moved into a working position in which the edge band located on the edge roller can be taken over by an edge feed of an edge banding machine. According to the invention, at least one cutting arrangement is arranged, preferably on the device or the edge banding machine or on a stand that is arranged in particular between the device and the edge banding machine, by means of which a portion of an edge band—in particular, a portion unwound from an edge roller—can be separated at a cutting position in the region of the working position.

The embodiment according to the invention does not require any rearrangement of edge bands or cartridges within the storing unit, since the edge band required in each case, regardless of its arrangement in one of the storage places, can be moved into the required plane relative to an edge banding machine solely due to the linear mobility of the storing unit. In this way, it is possible to omit the handling apparatus required for the previously necessary distribution of edge bands within the storing unit. In addition, there is no longer any need to transfer an entire edge band roller to an edge banding machine, since this band can now be fed directly from the storing unit in that the storage place containing the required edge band can be positioned beforehand, for example, opposite an edge feed of the edge banding machine.

According to a particularly preferred further development of the basic concept of the invention, at least one storage place of the storing unit can be designed in such a way that it can accommodate at least one edge band. In other words, this storage place can be designed in such a way that a loose edge band can be arranged or deposited therein—in particular, if the edge band is wound up to form an edge roller at least in some portions. As an alternative or in addition to this, at least one of the storage places can accommodate a cartridge that contains the edge band at least partially.

The storing unit has two opposing sides, and the design of its storage places can advantageously be adapted to the shape of the edge bands to be accommodated. Thus, at least one of the storage places can have at least one floor element extending at least partially between the sides of the storing unit. This can be designed, for example, in such a way that an edge band can be placed directly on this floor element or at least partially supported on it. As an alternative or in addition to this, at least one of the storage places can have at least one support element arranged in the region of each side of the storing unit. The support elements can be designed, for example, in such a way that a cartridge containing an edge band can be placed on these support elements or can be at least partially supported on them and/or moved in the longitudinal direction of the support element.

In this connection, according to a preferred further development, the invention provides that the floor element and/or at least one support element of at least one storage place be able to be mounted on the storing unit so as to be linearly movable. By corresponding movement of the floor element and/or support element that can be displaced in this way, in particular the height of the associated storage place available to accommodate an edge band or a cartridge containing the edge band can be adapted to the height required in each case. Specifically, an adaptation to edge bands having different widths or heights of their cartridges can thus be carried out. As a result, the storage place in question can be adapted with as little play as possible in relation to the edge band to be accommodated. It is also conceivably possible in this way to adapt the number of storage places, which can be increased by one or even several places—for example, by adapting them to correspondingly narrow edge bands.

According to a particularly preferred development of the invention, the device—in particular, the base frame and/or the storing unit and/or each storage place of the storing unit and/or a manipulator, which can move an edge roller and/or an edge cartridge, and/or a storage arrangement, which can accommodate one or a plurality of edge rollers, or/and at a storage place of the storage arrangement—can be equipped with at least one reading module. In an advantageous manner, this can be a so-called contactless reading module, which can then receive transmitted data in a correspondingly wireless manner. In any case, the reading module is set up to communicate with at least one transmission module of an edge band or a cartridge containing the edge band. For this purpose, for example, an RFID chip can be arranged in or on an edge band or the cartridge thereof, and the chip transmits the data stored in it to the reading module via a corresponding external stimulus. In this way, required information about the edge band to be arranged in one of the storage places can be transmitted to the device and can then be used to control the storing unit in particular. The information can contain, for example, specifications about the width and the decor or the color of the edge band in question. In this way, it is possible, for example, for the device and/or a controller that controls it to be more or less aware of the edge bands held in the storing unit and their respective storage places, in order to be able to provide the particular requested or required edge band.

It is conceivable that the reading module itself or an additional component contain a transmission unit, which in turn can transmit information to the transmission module of the edge band in question, which is then writable, for example. In this way, for example, information about the remaining length of the edge band can be stored in its transmission module, so that those edge bands which have a remaining length required for the upcoming edge banding are always used.

In particular with a view to preferably automated control of the device, it is considered particularly advantageous if the device has a drive by means of which the storing unit can accordingly be moved automatically relative to the base frame. As an alternative or in addition to this, the storing unit can also be moved manually relative to the base frame of the device. For example, a device that is rather simple in its expansion stage may require the manual movement of its storing unit, while its higher expansion stage provides a correspondingly controlled drive. In principle, a device equipped with such a drive can also enable its storing unit to be moved manually in order to facilitate maintenance work and/or, for example, to ensure that the device can be used by manual handling even if the drive is defective.

The device according to the invention can have an interface which can be coupled to at least one further component or machine. In principle, the interface can enable a mechanical and/or data-transferring coupling. This enables, for example, simple integration into existing system structures and their operational processes, since signals available from the existing system or the controller thereof can be transmitted to the device via the interface, and/or signals can be passed on from the device to the existing system or the controller thereof.

According to an advantageous embodiment of the invention, the device can have at least one drive unit via which an edge band can be actively driven at least in some portions. This means that a free end of the edge band can, for example, be movable from its arrangement within the storing unit and possibly also beyond it. In this way, the drive unit can at least transfer the edge band from its storage place to an edge banding machine. The guiding of the edge band into the edge banding machine can also take place entirely via the drive unit, or can at least be supported thereby. In the specific embodiment, an active rotation of the wound edge band and/or at least one friction wheel would be conceivable, for example, which has circumferential contact with the edge band or a component interacting with the edge band and drives or unwinds it by a rotation at least in some portions. The same also applies to the braking operation. In principle, the drive unit can interact with an edge band that is at least partially arranged within a cartridge, or with an edge band that is present without such a cartridge.

The device can preferably have at least one brake unit by means of which an edge band can be braked and/or fixed with respect to its mobility. Both the controlled drive and the uncontrolled movement behavior of the edge band are regarded as the mobility of the edge band, which can be attributed in particular to tensions within its material, which can result from the rolled-up state and/or temperature fluctuations. Of course, this also includes all other influences that cause movement of the edge band, such as vibrations. The brake unit is designed in such a way that it at least brakes the movement of the same—for example, by pulling on a portion of the edge band. The brake unit can preferably fix the edge band in such a way that control over its free end is always ensured. In this way, the independent retraction or movement of the free end of the edge band can be countered, in that this is more or less held by the brake unit. The brake unit can in principle interact with an edge band that is at least partially arranged within a cartridge or with an edge band that is present without such a cartridge.

The cutting arrangement according to the invention can be arranged in different ways. According to an advantageous embodiment, it is provided for the or for at least one cutting arrangement to be arranged on the base frame and/or on the storing unit and/or on an edge feed and/or on the edge banding machine and/or on a separate stand, which can be arranged between the device and the edge banding machine. For example, only one edge band portion, of which the length cut off by the cutting arrangement corresponds to the length to be processed, can be transferred to an edge banding machine. The cutting arrangement can in principle interact with an edge band that is at least partially arranged within a cartridge or with an edge band that is present without such a cartridge. When the cutting arrangement is properly arranged on the device or the storing unit, it is possible, when using an edge cartridge, to cut off the edge band already within the same or in any case flush with or free of overlap with the housing of the edge cartridge. This results in the advantage that retracting the edge band can be completely dispensed with as a working step when changing an edge roller or edge cartridge. This saves time.

In the context of the invention, it is conceivable that the device extend either vertically or horizontally in its intended arrangement. Accordingly, the storing unit can be linearly movable parallel to a vertical or parallel to a horizontal relative to the base frame. Depending upon the application, this results in advantageous options for using the available installation space. Furthermore, it is possible for the storing unit to be displaceable at an angle between 45° and 90°, and preferably between 75° and 90°, to the horizontal relative to the base frame. Such an arrangement can be realized in particular such that the orientation then has not only a directional component in the vertical direction, but also a second directional component in or counter to the feed direction of the workpieces to be coated with the edge band.

Since the number of storage places of the vertically-movable storing unit, which lie one above the other in relation to a vertical orientation, is already limited naturally by the particular ceiling height, this can be increased accordingly by a horizontal orientation of the storing unit. In particular, the height of the edge feed on an edge banding machine limits the maximum possible height of the storing unit for the direct unwinding of an edge band from its storage place, since the uppermost storage place must be in the plane of the edge feed for this purpose. As a result, the maximum number of possible storage places results from the space available below this plane. Any recesses in the base naturally allow greater heights for the storing unit, since, in its maximally lowered position, it could then be moved at least partially into such a recess.

The advantage of a vertical orientation of the device lies in the fact that the edge bands held in it can generally enter an edge banding machine without rotating about the longitudinal axis. The decisive factor here is its orientation in relation to its cross-section, which orientation is parallel to the wood-based panels usually processed horizontally. In contrast, a horizontal orientation of the device requires a 90° rotation of an edge band about its longitudinal axis in order for this edge band, which is then lying within the storing unit in relation to its cross-section, to be aligned parallel to the narrow edges of a wood-based panel. In particular, the rotation of an edge band about its longitudinal direction can stress its structure and negatively influence the reliable course during edge feeding. On the other hand, the horizontal orientation of the device allows a greater length of its storing unit, so that it accordingly provides more storage places for edge bands. The more advantageous orientation of the device is to be selected by the competent specialist in each individual case on the basis of the aforementioned criteria.

According to a preferred further development, the device can comprise at least one manipulator. This manipulator can, for example, be a multi-axis robot arm and/or a storage and retrieval machine (SRM). The manipulator is arranged and set up in such a way that it reaches every storage place of the storing unit. In this way, the manipulator can be used to load the storage places with edge bands and to empty them by removing the edge bands from the storage places or inserting them into the storage places, as required. Of course, this is independent of whether the respective edge bands are present as such or are arranged at least partially within a cartridge. Compared to manual loading and removal of the edge bands, the manipulator enables more extensive automation of the device.

In connection with the at least one manipulator, it is provided that the device according to the invention also be able to have a storage arrangement. The storage arrangement is used for the local provision of edge bands or cartridges containing edge bands. With the help of the manipulator, these can then be removed individually or at least in pairs from the storage arrangement and transferred to the storage facility of the device. In this way, the storage places of the storing unit can be individually equipped with edge bands from the storage arrangement. Conversely, the storage arrangement is used for the local provision of edge bands or cartridges containing edge bands, which can be removed from the storage device individually or at least in pairs by the manipulator in order then to be transferred to the storage arrangement.

By the combination of a storage arrangement and a manipulator, the number of locally available edge bands can be correspondingly increased, which enables shorter reaction times and/or a greater selection of edge bands that are different from one another.

According to a further expansion stage of the device according to the invention, based upon the presence of a manipulator, a transfer device can also be provided, by means of which further edge bands held in a nearby machine store can be accessed. Edge bands located in the machine store can be removed individually or at least in pairs by the transfer device and transferred to the manipulator, which can then be transferred to the storage arrangement and/or the storing unit. Conversely, edge bands located in the storage arrangement and/or the storing unit can be removed individually or at least in pairs by the manipulator and passed on to the transfer device, from where they can be transferred back to the machine store.

The device according to the invention which has now been presented enables an overall extremely economical provision of edge bands. In particular, the linear movability of the storing unit which can be loaded with edge bands makes the crucial contribution to this of placing an edge band into one of the free storage places in a more or less disordered manner. If necessary, this can be brought into the required plane, i.e., the working position, relative to an edge banding machine by simply moving the entire storing unit in order to be able to access the edge band located therein. A previous, and in particular mechanical, sorting of the edge bands is therefore no longer necessary. This is based upon the knowledge of data about the edge bands held in the storing unit, which data result from the communication which is possible in at least one direction between the device and the edge band in question or the cartridge containing the edge band. The currently required edge band can always be positioned in the plane of the edge feed of the edge banding machine by means of a corresponding controller in order to enter the edge banding machine. With further expansion stages, such as at least one manipulator and a storage arrangement for edge bands, the efficiency of the device can be increased further by increasing its reserve capacity.

Furthermore, the invention relates to an edge banding system which comprises an edge banding machine and at least one device described above. The device is arranged in the region of the edge banding machine in such a way that at least one edge band that can be arranged in the device can be fed at least partially to the edge banding machine. The at least partial feeding of an edge band takes place directly from the storing unit of the device. The advantages resulting from this have already been explained in more detail in connection with the device according to the invention, so that, in order to avoid repetition, reference is made at this point to the previous explanations.

According to a preferred further development of the edge banding system, the storage places of the device, which can be at least indirectly loaded with an edge band, can be arranged relative to the base frame in the plane of an edge feed of the edge banding machine by linear movement of the storing unit. In other words, the edge band required in each case is brought into the working position at level with the plane of the edge feed of the edge banding machine by linear movement of the entire storing unit in order to run directly from the storing unit into the edge feed.

The manipulator can advantageously have at least one vertical axis of rotation. As an alternative or in addition to this, the manipulator can have at least one vertical lifting axis and/or telescopic axis. The manipulator can be rotated accordingly via the vertical axis of rotation. The manipulator is able to move an edge band or a cartridge containing the edge band between different heights via the vertical lifting axis. The manipulator is able to displace the edge cartridges or edge rollers between the individual storage places via the telescopic axis. For example, the removal can take place from a first plane, while the delivery takes place in a second plane that differs from the first plane. The lifting axis or the axis of rotation or a possible telescopic axis do not have to be perpendicular, in general. Instead, it may be provided for the axis of rotation, the lifting axis, and/or the telescopic axis of the manipulator to be oriented such that the edge roller or edge cartridge can be displaced in the direction of the device and/or in the direction of a storage arrangement by means of the manipulator.

If several storage arrangements, e.g., two storage arrangements, are arranged in the region of the manipulator, and if they cannot be loaded via a linear axis or if cartridges or edge rollers cannot be withdrawn therefrom via a linear axis, it is possible—in particular, via the vertical axis of rotation of the manipulator—to always align the manipulator such that an edge band or a cartridge containing the edge band can be removed from or delivered to one of the storage arrangements.

It is preferably provided for an edge feed to be arranged on the edge banding machine, wherein the cutting arrangement is arranged on the edge feed adjacent to the working position of the device. As a result, the length of the edge band, which must be retracted again, can be minimized. In principle, it is possible, as an alternative or additionally, for the cutting arrangement to be arranged on the device—in particular, its base frame and/or storing unit—such that the cutting position lies within the cartridge. Retracting the edge band can even be dispensed with in this embodiment. Of course, in the previously mentioned alternative, the cutting arrangement can also be arranged on the device—in particular, on its base frame and/or storing unit—such that the cutting position is outside the cartridge.

The use of the device according to the invention and/or the edge banding system according to the invention is of course not limited to just the edge banding of wood-based panels. The edges of panels made of any material can be edge banded, such as those of solid wood panels. In the context of the invention, the mention of an edge band always means its presence without or with a cartridge containing it, regardless of whether this is explicitly mentioned or not.

The invention further relates to a method for changing an edge roller or edge cartridge in an above-described edge banding system. In this method, the following steps are carried out—in particular, in succession:
a. a first edge band located in the edge feed is cut off from a first edge roller and with the cutting arrangement at a cutting position;
b. the peeled off edge band remaining on the first edge roller is optionally retracted;
c. the storing unit is displaced such that the first edge roller is moved out of the working position, and a second edge roller is moved into the working position;
d. the edge band located on the second edge roller is captured by the edge feed and fed to processing.

With this method, a rapid change from an edge band just used to a further edge band is possible with minimal time expenditure. The duration of step sequence a. through d. is preferably 0.5 to 5 seconds, advantageously 1 to 3 seconds, and most preferably 1 to 2 seconds.

In general, the first and second edge rollers can be parts of a first and a second edge cartridge, wherein the above-described step a. is carried out at a cutting position inside or outside the first edge cartridge.

Ultimately, the present invention relates to a use of the device according to the invention or the edge banding system according to the invention. When the device or the edge banding system containing this device is used, it is provided that the particular edge band that can be provided by this means be in principle removed from a cartridge which contains it at least partially. In other words, for this purpose, the storing unit of the device is loaded with at least one cartridge containing an edge band roller, from which the edge band located therein is removed as required. Said cartridge is accommodated by one of the storage places of the storing unit of the device. Compared to the handling of open edge bands rolled up to form edge band rollers, the arrangement thereof in a cartridge offers easier handling overall.

### BRIEF DESCRIPTION OF THE DRAWINGS

The invention will be explained in more detail in the following with reference to FIGS. 1 through 11.

In the drawings:

FIG. 1 shows a device according to the invention in a perspectival representation,

FIG. 2 shows the device from FIG. 1 in its arrangement in front of an edge banding machine in a top view,

FIG. 3 shows the device from FIG. 1, in an extended expansion stage, in an otherwise unchanged representation,

FIG. 4 shows the expansion stage from FIG. 3, in an expansion stage extended by comparison thereto, in an otherwise unchanged representation,

FIG. 5 shows the expansion stage from FIG. 4 in an expansion stage, again extended by comparison, in an otherwise unchanged representation,

FIG. 6 shows two, side-by-side arrangements from FIG. 4 as a further expansion stage in an otherwise unchanged representation,

FIG. 7 shows two, side-by-side arrangements from FIG. 5 as a further expansion stage in an otherwise unchanged representation,

FIG. 8 shows the device according to the invention from FIG. 1 in a first alternative embodiment in an otherwise identical representation, rotated by 90°,

FIG. 9 shows the device according to the invention from FIG. 1 in a second alternative embodiment in an otherwise identical representation,

FIG. 10 shows a plan view similar to FIG. 2 with a cutting device provided according to the invention at a first position, and

FIG. 11 shows a further plan view, slightly enlarged compared to the illustration of FIG. 10.

### DETAILED DESCRIPTION OF PREFERRED EMBODIMENTS

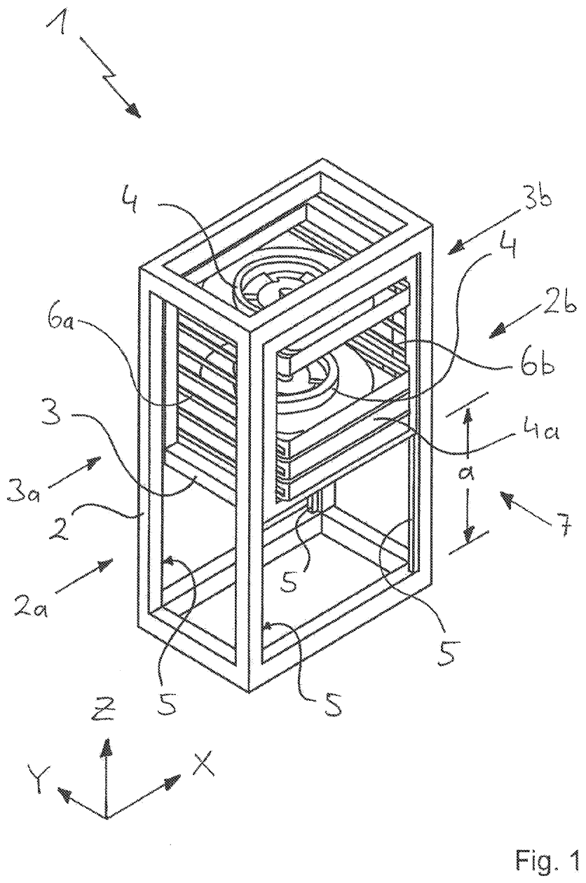

FIG. 1 shows a device 1 according to the invention in a perspectival representation. The device 1 comprises a base frame 2, which in the present case has frame structures with rectangular tubes connected to one another essentially at right angles. The design shown here is exemplary and represents only one possible embodiment of the base frame 2. A storing unit 3 which serves to accommodate edge bands 4 is arranged between two sides 2a, 2b of the base frame 2, which have frame structures spaced apart from one another. In the present case, the construction of the storing unit 3 is the same as that of the base frame 2, since it also has a frame structure with rectangular tubes connected to one another essentially at right angles.

Due to the correspondingly smaller design of the storing unit 3 compared to the base frame 2, the storing unit 3 in the embodiment shown here by way of example is located within the internal dimensions of the base frame 2, wherein the storing unit 3 is guided so as to be linearly movable with its opposite sides 3a, 3b on the sides 2a, 2b of the base frame 2. In contrast, the length of the storing unit 3 extending parallel to its sides 3a, 3b is shorter than the base frame 2, so that it is movable within the base frame 2 with a corresponding stroke length a relative to the base frame. For this purpose, rails 5 are arranged in a suitable manner on the base frame 2. As can be seen by way of example in FIG. 1, one of these rails 5 can be arranged on one of the opposing inner surfaces of the frame structures extending between the two sides 2a, 2b of the base frame 2, so that each of the sides 2a, 2b has two such rails 5. Regions of the storing unit 3 that correspond to these rails 5 (and are not shown in greater detail here) ultimately facilitate its linear mobility with respect to the base frame 2. The linear movement of the storing unit 3 is preferably carried out by a drive which cannot be seen here; however, it can of course take place manually as an alternative or in addition to this.

Looking at the storing unit 3, it becomes clear that it has a large number of support elements 6a, 6b arranged on its two sides 3a, 3b. In the present case, the support elements 6a, 6b are designed like rails, which each extend perpendicular to the length of the storing unit 3 on the two sides 2a, 2b of the base frame 2. The support elements 6a, 6b can be seen here on the inner surfaces of the rectangular tubes, located on each side 3a, 3b of the storing unit 3, of the frame structures. The support elements 6a, 6b can be mounted on the sides 3a, 3b of the storing unit 3 so as to be linearly movable in relation to their lateral spacing from one another, in a manner that is not shown in detail.

The support elements 6a, 6b subdivide the interior of the storing unit 3 into individual storage places 7, wherein two support elements 6a, 6b lying opposite one another in relation to the two sides 3a, 3b of the storing unit 3 define a storage place 7. The storage places 7 defined in this way serve to accommodate the edge bands 4, which in the present case are each arranged at least partially rolled up to form an edge roller within a cartridge 4a. The cartridges 4a have side surfaces which correspond to the support elements 6a, 6b and enable them to be pushed into and pulled out of the storing unit 3 accordingly. Alternatively, and not shown in more detail, the individual storage places 7 can also be defined by floor elements which then extend at least partially between the sides 3a, 3b of the storing unit 3.

The floor elements can be connected to the storing unit 3 in a fixed or movable manner, so that they enable it to be pulled out of the storing unit 3 in the manner of a drawer. In contrast to the loading of the storing unit 3 with cartridges 4a containing edge bands 4, the floor elements enable edge bands 4 to be accommodated directly—for example, by placing them on the floor elements. Of course, the floor elements can also be combined with the support elements 6a, 6b which accommodate the cartridges 4a. It is also conceivable that the support elements 6a, 6b serve to support floor elements, so that, in this way, edge bands 4 can also be arranged directly in the storing unit 3. Furthermore, what has been said above with regard to the support elements 6a, 6b can also apply to these floor elements, with regard to their possible change in spacing from one another by a movable connection to the storing unit 3.

The device 1 or the storing unit 3 can have a drive unit, not shown in detail, via which at least portions of an edge band 4 can be actively driven if required. The drive unit can interact either directly with the relevant edge band 4 or with a cartridge 4a containing the edge band 4. Furthermore, the device 1 or the storing unit 3 can have a brake unit, likewise not shown in detail, by means of which an edge band 4 can be braked and/or fixed with respect to its mobility. The brake unit can interact either directly with the relevant edge band 4 or with a cartridge 4a containing the edge band 4. The device 1 or the storing unit 3 can also have a cutting arrangement, also not shown in detail, by means of which a portion of an edge band 4 can be cut off. The cutting arrangement can interact either directly with the relevant edge band 4 or with a cartridge 4a containing the edge band 4. Depending upon the design, the drive unit or brake unit or cutting arrangement can also be at least part of a cartridge 4, which can be controlled via a corresponding control of the device 1 or of the storing unit 3. A division into two would also be conceivable in that the cartridges 4a comprise the corresponding mechanical parts of the drive unit or brake unit or cutting arrangement, while the device 1 or the storing unit 3 have the corresponding drive for this, which can then be coupled to them.

In principle, the device 1 can be aligned in such a way that its storing unit 3—as can be seen in FIG. 1—is linearly movable parallel to a vertical Z relative to the base frame 2. In contrast, the device 1 can of course also be used in an orientation rotated by 90°, so that its storing unit 3 is linearly movable parallel to a horizontal X relative to the base frame 2.

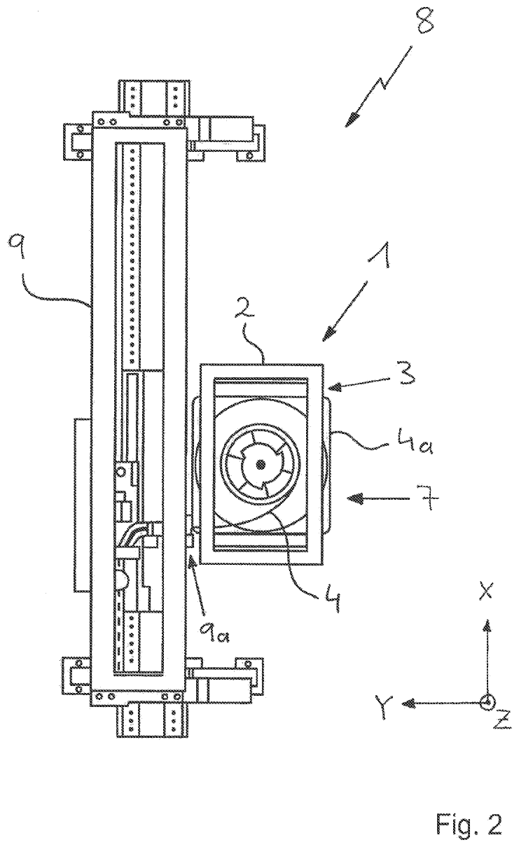

FIG. 2 shows the top view of an edge banding system 8, which comprises an edge banding machine 9 and the device 1 explained in more detail above. It can be seen that the device 1 is located directly in front of the edge banding machine 9 in relation to a spacing direction Y running at right angles to the horizontal X and to the vertical Z. As a result, the device 1 is arranged in the region of the edge banding machine 8 in such a way that one of the edge bands 4 arranged in the device 1 is guided directly from the storing unit 3 of the device 1 into the edge banding machine 9. The position of the device 1 is chosen so that the edge band 4 runs directly into an edge feed 9a of the edge banding machine 9, through which it is used, in a manner not shown, for edge banding panels, and in particular wood-based panels. Previously, the storage place 7 of the device 1 loaded with the desired edge band 4 was arranged in the plane of the edge feed 9a, in that its storing unit 3 was moved linearly by a movement running parallel to the vertical Z in the present case.

Due to the almost direct entry of an edge band 4 into the edge feed 9a of the edge banding machine 9, the otherwise exposed portion of an edge band 4 between the device 1 and the edge banding machine 9 is reduced to a minimum, which leads to significantly reduced stresses within the course of the edge band 4. In addition, the direct feeding of the edge band 4 into the edge banding machine 9 eliminates any threading effort and the adjustment work required here.

Depending upon the requirements, the edge banding system 8 can be designed in such a way that the device 1 can be moved relative to the edge banding machine 9, which, with regard to the representation of FIG. 2, means the displacement in and counter to directions parallel to the horizontal X and/or to the spacing direction Y. For example, the device can be movable relative to the device 1 in a direction running parallel counter to the spacing direction Y, in order to be able to carry out any maintenance work. Here, for example, free access to the edge feed 9a is made possible. Of course, this displaceability can also be used to move the device 1, for example, if necessary, between two edge banding machines 9 spaced parallel to one another, in order to be able to provide the edge band 4 required in each case on one or the other edge banding machine 9.

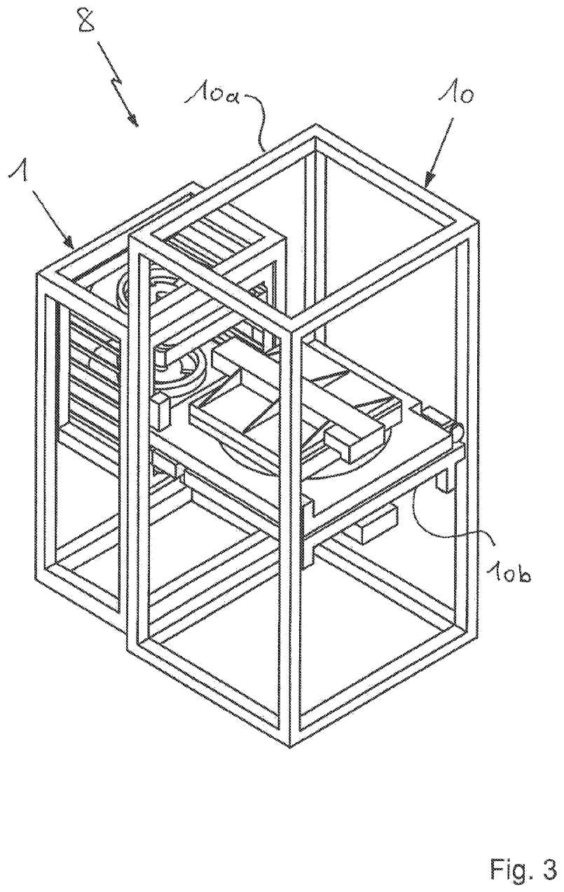

FIGS. 3 through 7 each show extended expansion stages of the device 1, by means of which the performance of the device can be increased with regard to the provision of edge bands 4.

FIG. 3 shows a first extended expansion stage in which the device 1 is combined with a manipulator 10. In the present case, an embodiment of the manipulator 10 as a storage and retrieval machine (SRM) is shown, which is linearly movable parallel to the lifting direction of the device 1. Specifically, for this purpose, the manipulator 10 has a lifting unit 10b mounted so as to be linearly movable in a frame 10a, which can accommodate at least one edge band 4 or a cartridge 4a loaded with an edge band 4. The manipulator 10 serves to load the device 1 with edge bands 4 or with cartridges 4a each containing an edge band 4, and to empty the device 1. In this expansion stage, the manipulator 10 can be loaded manually. The manipulator 10 can be moved synchronously with the device 1 by means of a corresponding coupling. This coupling can take place mechanically and/or by means of control technology. A corresponding control of the manipulator 10 enables the device 1 to be loaded and unloaded even during operation.

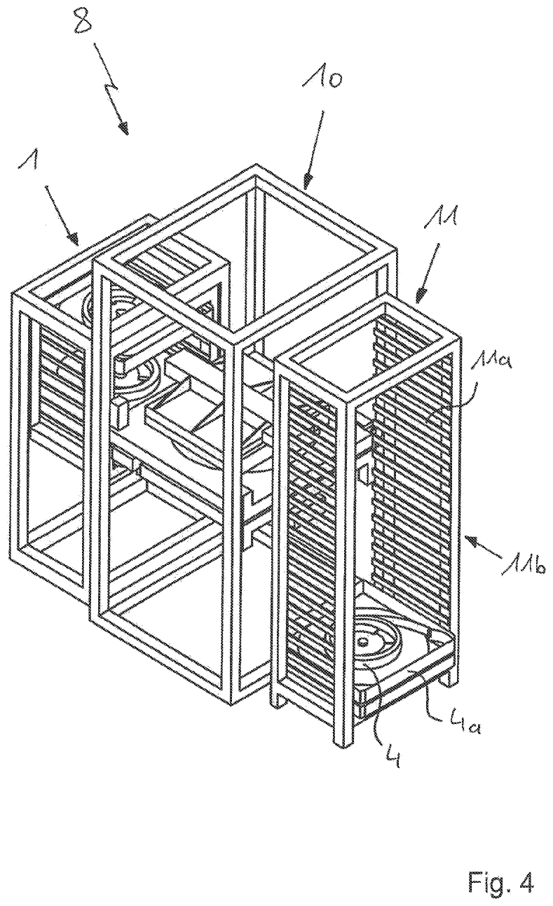

FIG. 4 shows a further expansion stage of the device 1 which, compared to the expansion stage from FIG. 3, is now additionally combined with a storage arrangement 11. In the present case, the storage arrangement 11 is designed like a shelf system with—as already explained above with regard to the device 1—lateral support elements 11a in the form of rails that have a plurality of slots 11b arranged one above the other for edge bands 4 or for cartridges 4a each containing one edge band 4. With the help of the manipulator 10, edge bands 4 that can be stored in the storage arrangement 11 can now be removed therefrom individually or at least in pairs and can be transferred to the device 1, wherein the storage places 7 of their storing unit 3 are correspondingly loaded. For this purpose, the linearly movable lifting unit 10b of the manipulator 10 is moved into the required plane of the storage arrangement 11, where it removes an edge band 4 or the cartridge 4a containing the edge band 4 from the related slot 11b. Then, if necessary, the lifting unit 10b of the manipulator 10 moves into another plane in order to transfer the edge band 4 or the cartridge 4a to a free storage place 7 of the storing unit 3 of the device 1. Of course, this can also be done the other way around, in order to feed edge bands 4 or cartridges 4a out of the device 1 to the storage arrangement 11.

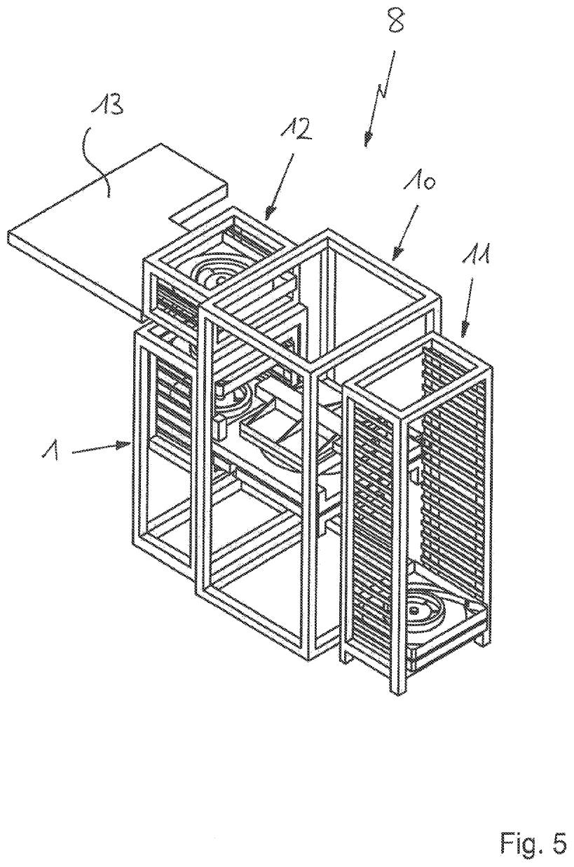

FIG. 5 illustrates the structure of a further expansion stage which additionally includes a transfer device 12. It can be seen that in the present case the transfer device 12 is arranged on the device 1, where it corresponds to a machine store 13. The machine store 13 is located above or directly on the edge banding machine 9 in a manner not shown in greater detail. In this arrangement, the storage arrangement 11 serves as a buffer for edge bands 4 or cartridges 4a, while the transfer device 12 feeds and removes new edge bands 4 or cartridges 4a—preferably, fully automatically. In other words, edge bands 4 or cartridges 4a, which can be stored in the machine store 13 provided here by way of example near the machine, can be transferred to the manipulator 10 individually or at least in pairs. In contrast, edge bands 4 or cartridges 4a arranged in the storing unit 3 and/or the storage arrangement 11 can be transferred individually or at least in pairs to the transfer device 12 by the manipulator 10.

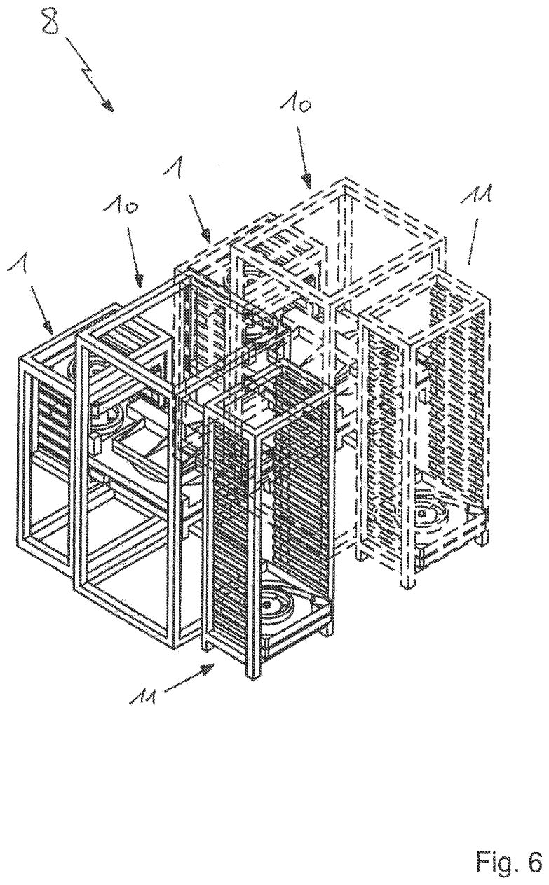

FIG. 6 shows an expansion stage which comprises a duplication of the structure already shown in FIG. 4. Specifically, two devices 1 are provided here, each of which is combined with its own manipulator 10 and a storage arrangement 11 located on the relevant manipulator 10. As a result of this structure, the two devices 1 can work alternately, so that correspondingly high cycle rates can be achieved. For this embodiment, the edge banding machine 9 has two edge feeds 9a, not shown here, in order to be able to process the edge bands 4 of the relevant device 1.

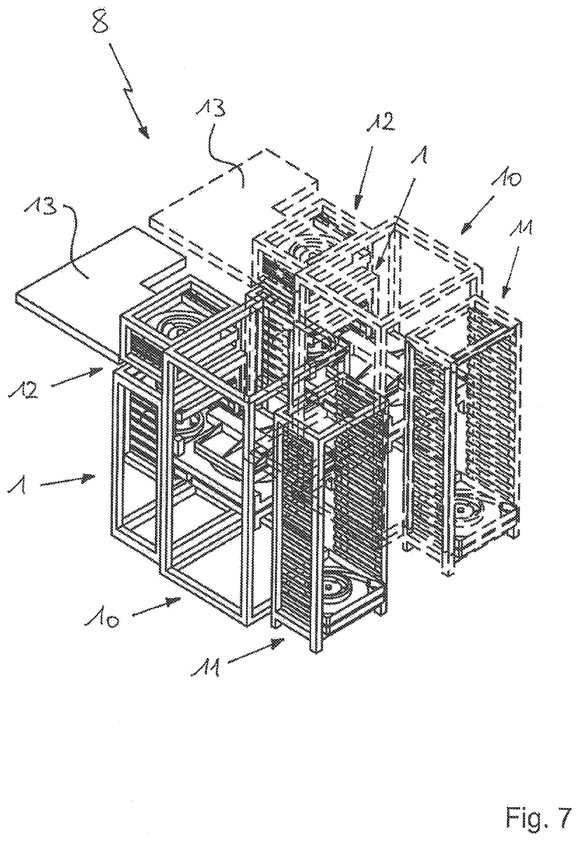

FIG. 7 shows a last possible expansion stage, which comprises a duplication of the structure already shown in FIG. 5. Specifically, two devices 1 are also provided, each of which is combined with its own manipulator 10 and a storage arrangement 11 located on the relevant manipulator 10, as well as a transfer device 12 and a machine store 13—in particular, near the machine. Here, too, the two devices 1 can work alternately in order to achieve a high cycle rate for the edge banding of panels.

In principle, the device 1 of all expansion stages can be equipped with at least one reading module (not shown in detail). Specifically, the reading module can be arranged in the region of the storing unit 3. It is also conceivable that each storage place 7 of the storing unit 3 be equipped with such a reading module. A reading module can be arranged also at other locations—for example, on the base frame 2 or the storage arrangement 11 or on one or a plurality of its storage places. The aim is the automated transmission of information about the respective edge bands 4 or cartridges 4a, which are currently in the storing unit 3 or which are removed from it or are just being fed in. Thus, the edge bands 4 or cartridges 4a can be equipped with a corresponding transmission module on which the required information is stored. Such a transmission module can preferably contain at least one RFID chip or can be designed as such a chip. The reading module or the reading modules are set up to communicate with the transmission modules. This can take place in one direction or in both directions, which means the mere reading out of data or a combination of reading out and writing of data by the reading module on a transmission module.

In an advantageous manner, the device 1 according to the invention can comprise at least one interface (not shown in greater detail here). This interface is then designed to be coupled to at least one further component or machine—in particular, mechanically and/or in a data-transferring manner. In this way, all components or machines of an edge banding system 8 can be controlled via a corresponding controller.

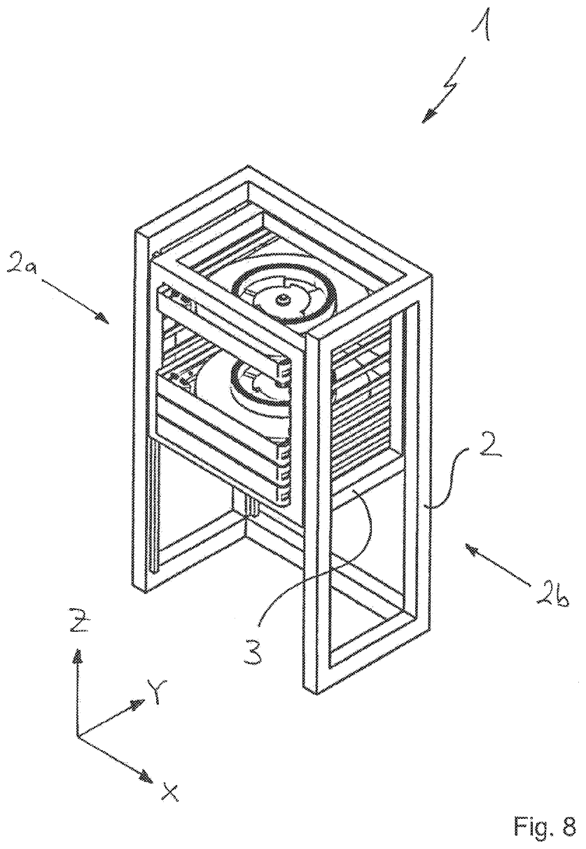

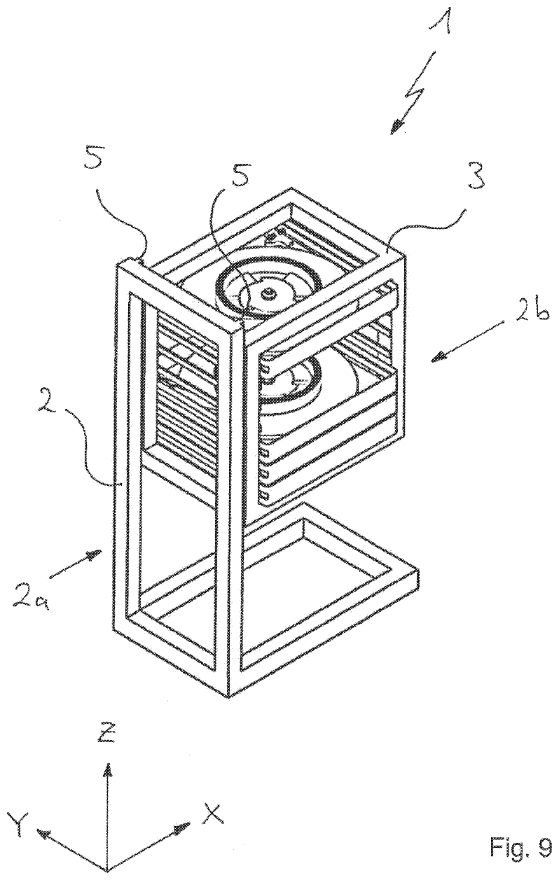

The device 1 shown in FIG. 1, and also shown only by way of example in the other FIGS. 3 through 7, is shown in FIGS. 8 and 9 in alternative embodiments—in each case in a perspectival representation. To avoid repetition and for better clarity, only some of the reference signs can be recognized here, since identical parts correspond to the parts already shown in FIGS. 1 through 7. The essential difference between the variants shown in FIGS. 8 and 9 lies in the different shape of the base frame 2 carrying the storing unit 3.

It can be seen from FIG. 8 that, in this variant of an embodiment, the frame structures each located on one of the two sides 2a, 2b of the base frame 2 are connected to one another via two rectangular tubes extending between them and parallel to the horizontal X. In contrast, the base frame 2 shown in FIGS. 1 and 3 through 7 has a total of four rectangular tubes connecting its two frame structures, each located on one side 2a, 2b, which tubes extend there between the opposite corners of said frame structures and parallel to the horizontal X. In the variant shown in FIG. 8, the rectangular tubes connecting the frame structures lie one above the other in relation to the vertical Z, so that the base frame 2 is essentially U-shaped in a top view, which is not shown in detail here.

FIG. 9 shows a variant of an embodiment, in which the view of the base frame 2 may be designated as L-shaped. It can be seen that the base frame 2 has a frame structure located on only one side 2a, while the opposite side 2b is more or less frameless. As already shown in FIGS. 1 through 7, the lower region of the base frame 2, which is composed of rectangular tubes, is designed to be closed. Specifically, the two rectangular tubes running parallel to the horizontal X each extend away from a lower corner of the frame structure located on the side 2a, and they are connected to one another at the end via a rectangular tube running parallel to the spacing direction Y. With the inclusion of the frame structure located on the side 2a, a closed, essentially rectangular shape is produced.

Further variants, not shown in detail here, for the base frame 2 are also conceivable—for example, in the form of a central lifting column below the storing unit 3.

Of course, the profiles referred to as rectangular tubes in the context of the description can also—unlike in FIGS. 1 through 9—have a different cross-sectional shape, such as a U-, C-, or L-shape. A design as a round tube is also conceivable here. Combinations of the above are also possible, as well as variants thereof within a base frame 2.

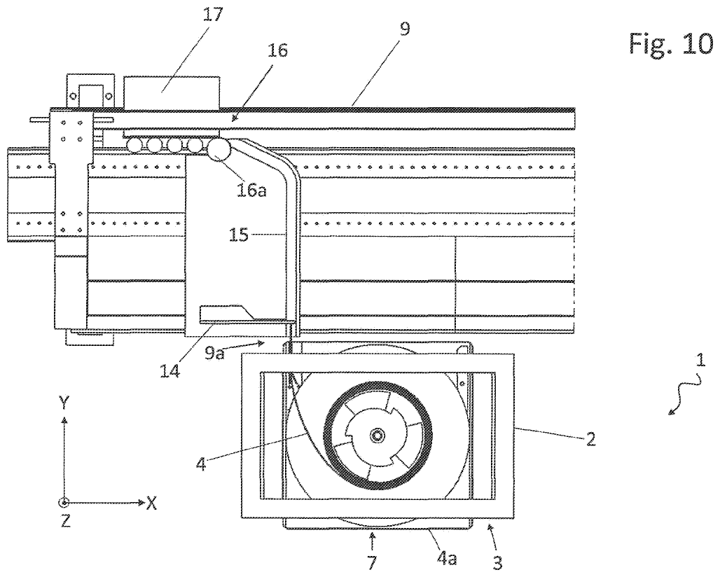

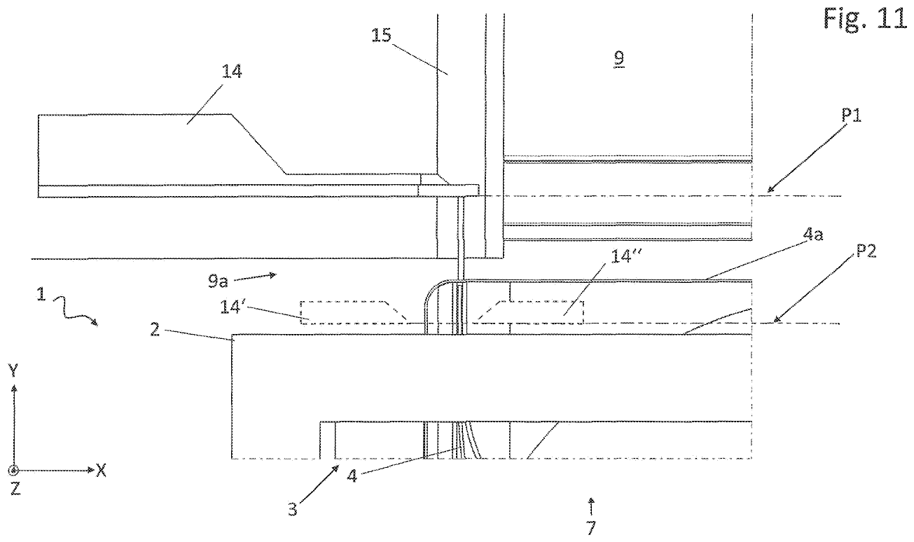

The function of the cutting arrangement 14, 14′, 14″ according to the invention is explained in more detail with reference to FIGS. 10 and 11. FIGS. 10 and 11 show a detail of an edge banding system according to the invention in the region of an edge banding machine 9, adjacent to which the device 1 according to the invention is arranged. In the device 1 according to the invention, an edge roller or edge cartridge 4a is in the working position in the example shown. Working position means that the edge roller or edge cartridge 4a is located in the storing unit 3 in the vertical direction Z at level with the edge feed 9a, so that the edge band 4 is pulled in from the edge roller or from the edge cartridge 4a via the edge feed 9a into an edge feed line 15 by means of a suitable pull-in mechanism (not shown) and is transported in the direction of a pressure unit 16, which generally has at least one pressure roller 16a, in order to be pressed there against the narrow side of a workpiece 17. As shown in FIG. 10, the edge roller or edge cartridge 4a is in the working position. In the example of FIG. 10, a cutting arrangement 14 is arranged on the edge banding machine 9 in the region of the working position. The cutting arrangement is preferably located in the immediate vicinity of the edge roller or edge cartridge 4a. Immediate vicinity means that the cutting arrangement 14 should be arranged at least in the region of the end, remote from the pressure device 16, of the feed line 15. As in the example of FIG. 10, this can be achieved in that the cutting arrangement 14 is arranged on or in the region of the end, facing the device 1, of the feed line 15.

Alternatively or additionally, a cutting arrangement 14′ or 14″ can also be arranged on the device 1 itself, so that the cutting arrangement 14′ or 14″ is then arranged in the region of the edge feed 9a on the portion, facing the feed line 15, of the device 1 or base frame 2 or storing unit 3. It can advantageously be provided for the cutting arrangement 14′ or 14″ to be arranged in the region of the device 1 such that, if the edge roller is designed as an edge cartridge 4a, it is able to cut off the edge band 4 at a point which is still located inside the edge cartridge 4a (this cutting position is denoted by P2 in FIG. 11), or is outside the edge cartridge 4a. By way of example, this cutting position is denoted by P2 in FIG. 11. The alternative or additional arrangement of the cutting arrangement 14 on the edge banding machine 9 or a stand (not shown) between the edge banding machine 9 and the device 1 cuts off the edge band 4 at a cutting position P1. In principle, it applies to each of the cutting arrangements 14, 14′, 14″ that they can be designed as a knife which can be displaced into the transport path of the edge band 14 in order to cut through the edge band at position P1 or P2, in order to separate a cut-off edge band to be attached to a workpiece 17 from the rest of the edge roller.

The advantage of arranging the cutting arrangement in the region of the working position of the edge roller or edge cartridge 4a is that, before switching to another edge roller or edge cartridge 4a, the edge band does not have to be retracted again over the entire feed line 15, i.e., it does not have to be wound onto the roller or retracted into the edge cartridge 4a, but is cut off already, such that the step of retracting or reeling can be saved upon. This saves time, and one can switch to a different edge band. This is particularly advantageous if the cutting arrangement can cut off the edge band 4 already within an edge cartridge 4a, as indicated, for example, by the positions of the cutting arrangements 14′ or 14″, since the associated edge cartridge 4a is then immediately moved from the working position into a storage position after cutting, and a different edge cartridge can be brought into the working position by moving the storing unit 3.

### REFERENCE SIGNS

1 device
2 base frame of 1
2a side of 2
2b side of 2
3 storing unit of 1
3a side of 3
3b side of 3
4 edge band
4a cartridge—in particular, containing 4
5 rail on 2
6a support element on 3
6b support element on 3
7 storage place of 3
8 edge banding system
9 edge banding machine of 8
9a edge feed of 9
10 manipulator of 8
10a frame of 10
10b lifting unit of 10
11 storage arrangement of 8
11a support element of 11
11b slot of 11
12 transfer device of 8
13 machine store of 8
14 cutting arrangement on 9, 9a
14′ cutting arrangement on 2 or 3
14″ cutting arrangement on 2 or 3
15 edge feed line
16 pressure unit
16a pressure roller
a stroke length of 3 in 2
P1 cutting position
P2 cutting position
X horizontal
Y spacing direction
Z vertical

1. A device (1) for providing edge bands (4), comprising a storing unit (3) having individual storage places (7), which are structured to be at least indirectly loaded with edge bands (4) that each form an edge roller at least in some portions, wherein the storing unit (3) is arranged to be linearly movable in or on a base frame (2) such that a selected edge roller can be moved into a working position in which the edge band (4) located on the edge roller can be taken over by an edge feed (9a) of an edge banding machine (9), and at least one cutting arrangement (14; 14′; 14″), by means of which a portion of an edge band (4), namely a portion of the edge band (4) unwound from an edge roller, can be separated at a cutting position (P1, P2) in the region of the working position.

2. The device (1) according to claim 1, wherein at least one of the storage places (7) is designed to accommodate at least one edge band (4) and/or at least one cartridge (4a) that contains the edge band (4) at least partially.

3. The device (1) according to claim 1, wherein the storing unit (3) has two opposite sides (3a, 3b), wherein at least one of the storage places (7) has at least one floor element extending at least partially between these sides (3a, 3b) and/or at least one support element (6a, 6b) arranged in the region of each side (3a, 3b).

4. The device (1) according to claim 3, the floor element and/or the support elements (6a, 6b) of at least one storage place (7) is/are mounted on the storing unit (3) so as to be linearly movable.

5. The device (1) according to claim 1, wherein the base frame (2) and/or the storing unit (3) and/or each storage place (7) of the storing unit (3) and/or a manipulator (10), which can move an edge roller and/or a cartridge (4a), and/or a storage arrangement (11), which can accommodate one or a plurality of edge rollers, or/and at a storage place (11b) of the storage arrangement (11)—is equipped with at least one reading module, which is set up to communicate with a transmission module—in particular, an RFID chip—of an edge band (4) or a cartridge (4a) containing the edge band (4).

6. The device (1) according to claim 1, wherein the storing unit (3) can be moved relative to the base frame (2) by an automated drive and/or manually.

7. The device (1) according to claim 1, further comprising at least one interface which can be coupled to at least one further component or machine in a mechanical and/or in a data-transferring manner.

8. The device (1) according to claim 1, further comprising a drive unit via which an edge band (4), which is at least partially arranged within a cartridge (4a), can be actively driven at least in some portions.

9. The device (1) according to claim 1, further comprising a brake unit via which an edge band (4) at least partially arranged within a cartridge (4a) can be braked and/or fixed with respect to its mobility.

10. The device (1) according to claim 1, wherein the or at least one cutting arrangement (14; 14′; 14″) is arranged on the base frame (2) and/or on the storing unit (3) and/or on a separate stand.

11. The device (1) according to claim 1, wherein the storing unit (3) can be linearly moved parallel to a vertical (Z) or parallel or at an angle between 45° and 90°, and preferably between 75° and 90°, to a horizontal (X) relative to the base frame (2).

12. The device (1) according to claim 1, further comprising a manipulator (10), by means of which each storage place (7) can be loaded with an edge band (4), or a cartridge (4a) at least partially containing the edge band (4), and can be emptied.

13. The device (1) according to claim 12, further comprising a storage arrangement (11) from which edge bands (4) which can be stored therein can be removed individually or at least in pairs by the manipulator (10) and can be transferred to the storage places (7) for loading the storing unit (3), wherein edge bands (4) which can be arranged in the storing unit (3) can be removed therefrom individually or at least in pairs by the manipulator (10) and can be transferred to the storage arrangement (11).

14. The device (1) according to claim 12, further comprising a transfer device (12) by which edge bands (4) that can be stored in a machine store (13) can be transferred individually or at least in pairs to the manipulator (10), wherein edge bands (4) that can be arranged in the storing unit (3) and/or the storage arrangement (11) can be transferred individually or at least in pairs by the manipulator (10) to the transfer device (12).

15. An edge banding system (8), comprising an edge banding machine (9) and at least one device (1) for providing edge bands, wherein the at least one device (1) is arranged in the region of the edge banding machine (9) in such a way that at least one edge band (4) that can be arranged in the device (1) can be fed directly from a storing unit (3) of the device (1) at least in some portions to the edge banding machine (9), the device (1) comprising the storing unit (3) having individual storage places (7), which are structured to be at least indirectly loaded with the at least one edge band (4) that each form an edge roller at least in some portions, wherein the storing unit (3) is arranged to be linearly movable in or on a base frame (2) such that a selected edge roller can be moved into a working position in which the at least one edge band (4) located on the edge roller can be taken over by an edge feed (9a) of an edge banding machine (9), and at least one cutting arrangement (14; 14′; 14″), by means of which a portion of the at least one edge band (4), namely a portion of the edge band (4) unwound from an edge roller, can be separated at a cutting position (P1, P2) in the region of the working position.

16. The edge banding system (8) according to claim 15, wherein the storage places (7) of the device (1), which can each be at least indirectly loaded with an edge band (4), can be arranged relative to the base frame (2) in the plane of an edge feed (9a) of the edge banding machine (9) by linear movement of the storing unit (3).

17. The edge banding system (8) according to claim 15, further comprising a manipulator (10), by means of which each storage place (7) can be loaded with an edge band (4), or a cartridge (4a) at least partially containing the edge band (4), and can be emptied, wherein the manipulator (10) can have at least one vertical axis of rotation and/or at least one vertical lifting axis and/or telescopic axis, wherein the axis of rotation, the lifting axis, and/or the telescopic axis are oriented such that the edge roller or edge cartridge can be displaced in the direction of the device (1) and/or in the direction of a storage arrangement (11) by means of the manipulator (10).

18. The edge banding system (8) according to claim 17, further comprising at least two of the storage arrangements (11) that are arranged in the region of the manipulator (10).

19. The edge banding system (8) according to claim 15, further comprising an edge feed (9a) arranged on the edge banding machine (9), wherein the at least one cutting arrangement (14) is arranged on the edge feed (9a) adjacent to the working position of the device (1).

20. The banding system (8) according to claim 15, wherein the at least one cutting arrangement (14′; 14″) is arranged on the base frame (2) and or the storing unit (3) of the device (1) such that the cutting position (P2) lies within the cartridge (4a).

21. A method for changing an edge roller or edge cartridge (4a) in an edge banding system (8),
the edge banding system (8) comprising an edge banding machine (9) and at least one device (1) for providing edge bands, wherein the at least one device (1) is arranged in the region of the edge banding machine (9) in such a way that at least one edge band (4) that can be arranged in the device (1) can be fed directly from a storing unit (3) of the device (1) at least in some portions to the edge banding machine (9), the device (1) comprising the storing unit (3) having individual storage places (7), which are structured to be at least indirectly loaded with the at least one edge band (4) that each form an edge roller at least in some portions, wherein the storing unit (3) is arranged to be linearly movable in or on a base frame (2) such that a selected edge roller can be moved into a working position in which the at least one edge band (4) located on the edge roller can be taken over by an edge feed (9a) of an edge banding machine (9), and at least one cutting arrangement (14; 14′; 14″), by means of which a portion of the at least one edge band (4), namely a portion of the edge band (4) unwound from an edge roller, can be separated at a cutting position (P1, P2) in the region of the working position,
the method comprising the steps of:
a) cutting off a first edge band located in the edge feed (9a) from a first edge roller and with the at least one cutting arrangement (14; 14′; 14″) at a cutting position (P1; P2);
b) retracting any peeled off edge band remaining on the first edge roller is retracted;
c) displacing the storing unit (3) such that the first edge roller is moved out of the working position, and a second edge roller is moved into the working position; and
d) capturing the edge band located on the second edge roller by the edge feed (9a) and fed to processing.

22. The method according to claim 21, wherein the first and second edge rollers are parts of a first and a second edge cartridge, wherein step a) is carried out at a cutting position (P1) inside (P2) or a cutting position outside (P1) the first edge cartridge.

23. A method of using a device (1) or of an edge banding system (8) for providing edge bands (4), wherein the respective edge band (4) is removed from a cartridge (4a) which contains the edge band at least partially and which is received by a storage places (7),
wherein the device (1) comprises a storing unit (3) having individual storage places (7), which are structured to be at least indirectly loaded with edge bands (4) that each form an edge roller at least in some portions, wherein the storing unit (3) is arranged to be linearly movable in or on a base frame (2) such that a selected edge roller can be moved into a working position in which the edge band (4) located on the edge roller can be taken over by an edge feed (9a) of an edge banding machine (9), and at least one cutting arrangement (14; 14′; 14″), by means of which a portion of an edge band (4), namely a portion of the edge band (4) unwound from an edge roller, can be separated at a cutting position (P1, P2) in the region of the working position, and
wherein the edge banding system (8) comprises an edge banding machine (9) and at least one device (1) for providing edge bands, wherein the at least one device (1) is arranged in the region of the edge banding machine (9) in such a way that at least one edge band (4) that can be arranged in the device (1) can be fed directly from a storing unit (3) of the device (1) at least in some portions to the edge banding machine (9), the device (1) comprising the storing unit (3) having individual storage places (7), which are structured to be at least indirectly loaded with the at least one edge band (4) that each form an edge roller at least in some portions, wherein the storing unit (3) is arranged to be linearly movable in or on a base frame (2) such that a selected edge roller can be moved into a working position in which the at least one edge band (4) located on the edge roller can be taken over by an edge feed (9a) of an edge banding machine (9), and at least one cutting arrangement (14; 14′; 14″), by means of which a portion of the at least one edge band (4), namely a portion of the edge band (4) unwound from an edge roller, can be separated at a cutting position (P1, P2) in the region of the working position.
